(19) United States
(12) Patent Application Publication
(10) Pub. No.: US 2024/0359414 A1
(43) Pub. Date: Oct. 31, 2024

(54) SOFT GOODS FROM A SYSTEM OF MOLDING AND PRESSING USING A SLURRY CONTAINING FIBERS WITH A SECOND ELEMENT AT LEAST PARTIALLY EMBEDDED THEREIN

(71) Applicant: Simplifyber, Inc., Raleigh, NC (US)

(72) Inventors: Maria Intscher-Owrang, Brooklyn, NY (US); Philip Cohen, Nashville, TN (US); Joseph Miller, Raleigh, NC (US); Juliana Jardim, Raleigh, NC (US)

(21) Appl. No.: 18/646,383

(22) Filed: Apr. 25, 2024

Related U.S. Application Data
(60) Provisional application No. 63/461,778, filed on Apr. 25, 2023.

(51) Int. Cl. B29C 70/68; B29C 70/42; B29K 105/08; B29L 31/00; B29L 31/34

(52) U.S. Cl. CPC B29C 70/682; B29C 70/42; B29K 2105/0854; B29L 2031/34; B29L 2031/722

(57) ABSTRACT

The present invention discloses a shaped soft goods article that includes a first material, and second element at least partially embedded therein. The first material is a unitary non-woven material having at least one three-dimensional feature that is made from a slurry containing at least one type of natural or synthetic fibers and at least one of crosslinkers, natural and/or synthetic adhesives, biobased and/or synthetic thermoplastics, including nanocellulose, and/or latex. The second element can be functional or decorative.

### PRIORITY CLAIM

This application claims the benefit of U.S. Provisional Patent Application Ser. No. 63/461,778 filed on Apr. 25, 2023, which is incorporated by reference herein in its entirety.

### FIELD OF THE INVENTION

The field of the invention is apparatus and method for molding a three-dimensional article and, more specifically, for molding a two-or three-dimensional article from an aqueous slurry that contains a plurality of fibers with a second element at least partially embedded therein.

### BACKGROUND OF THE INVENTION

The current process for creating soft goods, such as clothing, footwear (e.g., shoe uppers), bags, furniture, medical supplies, cleaning tools and consumables, toys, automotive interior parts, cases and housings for consumer electronics, and other soft goods is often wasteful and includes numerous steps. Within each manufacturing step is a separate, inefficient, labor-intensive process that often requires transport of materials between the steps. Scrap materials (e.g., cloth that is cut but not used) are often simply discarded, adding to the waste in the process. Additionally, raw materials are typically provided in flat shapes and must be formed into the final desired shape, different equipment and processes must frequently be employed when small changes in the final design are implemented, and surface feature and/or texture final design must be added in a secondary operation. Further, customization of products is difficult and requires additional steps. Solutions are needed in the art to provide a manufacturing process for shaped items to be customized, color-blocked, decorated, and/or given the ability to have areas of higher and lower stability without the need for additional, labor-intensive and time-consuming steps such as sewing. These and other shortcomings in the prior art are addressed by the present invention, as disclosed herein.

### SUMMARY OF THE INVENTION

According to one aspect of the present invention, a shaped soft goods article, and method of making the same, are disclosed. The shaped soft goods article includes a first material and a second element at least partially embedded within the first material. The first material is a unitary non-woven material having at least one three-dimensional feature comprised of at least one type of natural or synthetic fibers and at least one of crosslinkers, natural and/or synthetic adhesives, biobased and/or synthetic thermoplastics, including nanocellulose, and/or latex. The second element can be a functional or decorative element.

According to another aspect of the present invention, the second element may be partially embedded within the first material, fully embedded within the first material, extend entirely through the first material, or affixed to an outer surface of the first material during the forming process.

According to a further aspect of the invention, additional elements may be added to the first material and/or second element.

One advantage of the present invention is that decorative items may enhance the look and feel of a soft goods article without requiring additional post-forming processes.

Another advantage of the present invention is that functional elements can be added without the need for post-forming processes that add functions, such as but not limited to power sources, electronic devices, and sensors, that are not otherwise present in the first material.

A further advantage of the present invention is that structural materials can be used to (locally) strengthen the first material without the need for post-forming processes.

These and other advantages will be apparent to one of skill in the art in light of the present disclosure and drawings.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows an exploded perspective view of one embodiment of the molding apparatus of the present invention;

FIG. 2 shows a partial perspective exploded view of another embodiment of the molding apparatus of the present invention;

FIG. 3 shows a top view of one embodiment of the first molding screen;

FIG. 4 shows a top view of one embodiment of the second molding screen;

FIGS. 5A-G shows diagrammatic cross-sectional views of configurations of first

materials and second elements of the present invention;

FIG. 5H shows one embodiment of a second element having a web-like structure; and

FIGS. 6A-G shows a series of cross-sectional diagrammatic images of one embodiment of the molding process of the present invention.

### DETAILED DESCRIPTION OF THE INVENTION

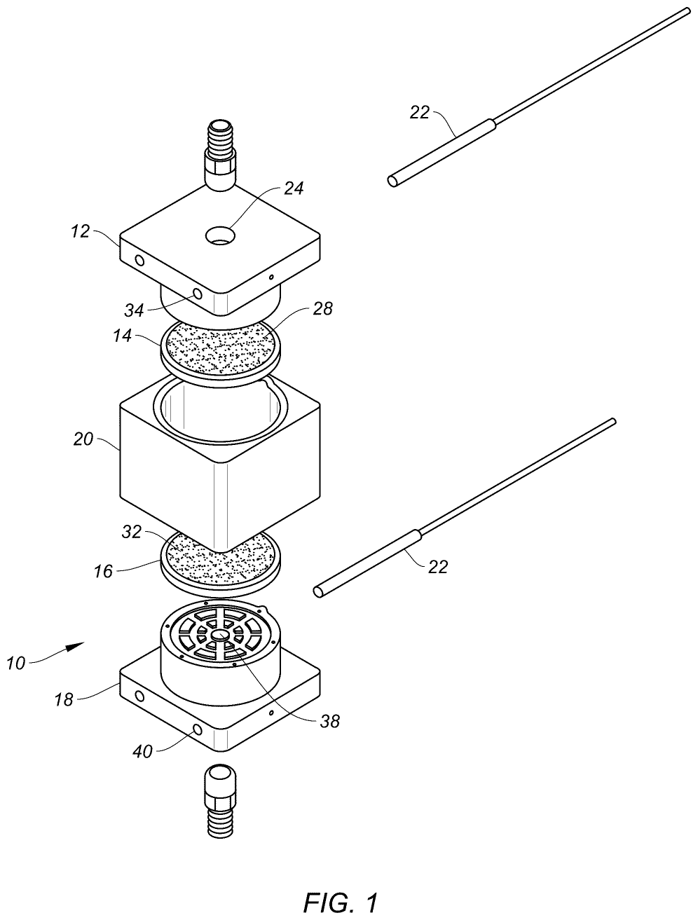

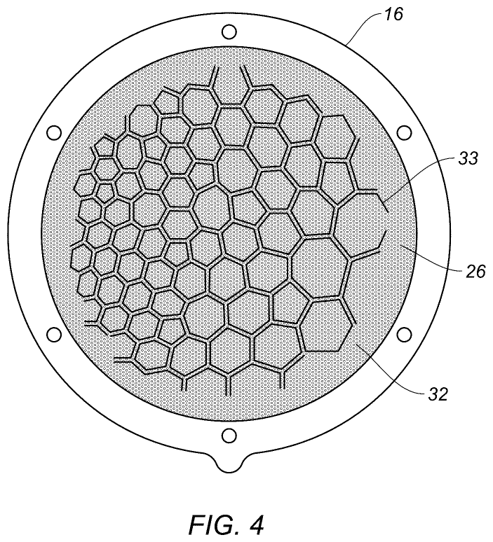

Referring now to FIGS. 1-6, one embodiment of the present invention is an article 11 having at least one contour, the article is comprised of a first material 13 and a second element 15. The second element 15 is at least partially embedded therein, affixed thereon and/or extending therethrough the first material 13 during the operation forming the first material 13. In some embodiments, a third material 17 may be also utilized as described herein.

Common articles (or components thereof) formed using the methods and apparatus 10 disclosed herein include clothing, footwear (e.g., shoe uppers), bags, furniture, medical supplies, cleaning tools and consumables, toys, automotive interior parts, cases and housings for consumer electronics, and other soft goods. Examples of clothing articles include, but are not limited to, shirts, shorts, dresses, skirts, pants, socks, vests, sweaters, scarves, hats, gloves, mittens, and undergarments. Examples of bags include, but are not limited to, handbags, purses, backpacks, bookbags, satchels, clutches, travel cases, luggage, and toiletry cases. Examples of automotive interior parts include, but are not limited to, interior panels, interior trim, seat upholstery and covers, floor mats, dashboard panels and covers and steering wheel covers. Examples of medical applications include slings, casts, wipes, bandages, artificial limbs, support garments, posture correcting garments, brace supports, canes, crutches and protective coverings. The above listing of articles is intended to be exemplary and non-limiting.

Referring now to FIGS. 1-4, one manner in which the first material 13 can be formed is via molding a molding operation. In the embodiment shown, the apparatus 10 includes a first pressing unit 12, a first molding screen 14, a second molding screen 16, a lower pressing unit 18, a pressing chamber sleeve 20, and a heating apparatus 22.

The method and apparatus 10 that can be used in conjunction with molding the first material 13 includes providing an aqueous solution that includes a plurality of fibers (“the slurry 23”). The slurry 23 can include natural fibers, synthetic fibers or a combination thereof. Examples of natural, or bio-based, fibers include, but are not limited to, pulp, lyocell, hemp, and wool. Examples of synthetic fibers include, but are not limited to, nylon and polyester. The slurry 23 may additionally include starches, surfactants, water retention agents, viscosifiers, crosslinkers, binding agents, and/or pH and charge modifiers. The above listing of ingredients is intended to be exemplary and non-limiting. The molding process converts the slurry 23 into a solid fibrous molded part 25 having a desired shape and surface features by draining and/or evaporating the water from slurry 23 during the molding process. One suitable slurry is disclosed in U.S. patent application Ser. No. 17/466,792, the disclosure of which is hereby incorporated by reference.

An example of the aforementioned slurry may contain but is not limited to the following content: water (20-99.99%), fibers (0.0075-60%), other additives (0.0025-20%).

The slurry 23 can be created by combining the fibers, water and any other ingredients desired into a mixer (not shown). Once in the mixer, the ingredients are mixed until all ingredients are dispersed, and the slurry 23 takes on the form of a foam-like mixture or homogeneous fiber dispersion.

Subsequent fiber modifiers and/or coatings to the final solid fibrous molded part 25 can be added that include but are not limited to synthetic, natural or biobased waxes; latexes; polyacrylates; polyvinyl chloride; silicones; and/or polyurethanes.

Referring now to FIG. 1, the first pressing unit 12 includes a first inlet 24 that can be used as a port to apply either a vacuum (i.e., negative pressure) or positive pressure, or to provide airflow or heat to the interior of the apparatus 10 before, during or after the molding process. The first inlet 24 may be adapted to receive a removable adapter that may be attachable to a hose or the like that is, e.g., fluid communication with a heat, airflow, vacuum and/or positive pressure source (not shown). The first pressing unit also provides the structural stability to one side of the apparatus 10 enabling significant pressure (e.g, from a hydraulic device) to be applied to the slurry 23 during the molding process. Additional ports may be included in the first pressing unit to provide for, e.g., drainage of the water from the slurry 23 during the molding process. Additionally, the first pressing unit 12 may also include one or more slots 34 for receiving a heating apparatus 22.

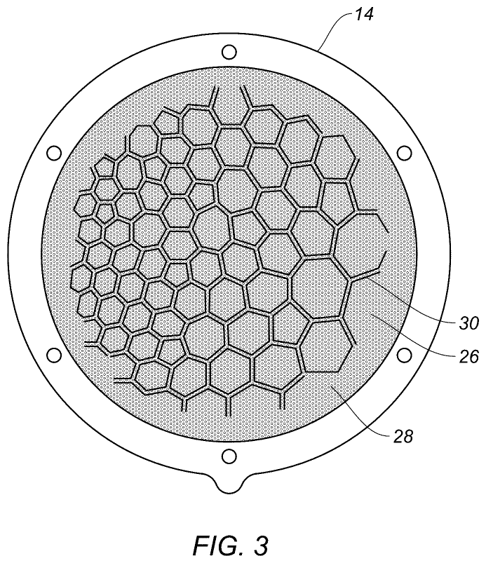

Referring now to FIGS. 1 and 3, the first molding screen 14 is generally a perforated molding screen. The first molding screen 14 partially defines a void 26 in which the slurry 23 is molded into a solid. The first molding screen can be substantially flat or, more preferably defines a three-dimensional shape. The first molding screen may be a positive mold or a negative mold. The first molding screen 14 preferably includes a series of openings 28 that are sized to permit water to drain therethrough and/or steam to pass therethrough during the molding process. The openings 28 are also preferably sized to retain the fibers in the slurry 23 within the void as the slurry 23 is molded into a solid during the molding process. For example, openings 28 have a diameter preferably range from approximately 0.1 mm to approximately 10 mm, and openings 28 between approximately 0.5 mm and approximately 2 mm have been found to have particular utility. The size of the openings 28 may be selected based on a number of factors, including the size of the fibers in the slurry 23, the amount of water necessary for draining, and the surface texture of the final molded product. The first molding screen 14 may also include secondary relief patterns 30. In the embodiment shown the secondary relief patterns are generally shown as being hexagonal in shape. For example, the relief patterns may be raised into the void 26 or depressed away from the void 26, or a combination thereof. In addition, the secondary relief patterns 30 are not limited to hexagonal and may take on any shape or shapes desired by designer. For example, the relief patterns could optionally define text on the finished molded product. The apparatus 10 may function with a variety of first molding screens 14 that can be swapped out depending on the desired final product.

Referring now to FIGS. 1, 2 and 4, the second molding screen 16, like the first molding screen 14, is generally a perforated molding screen. The second molding screen 16 partially defines the void 26 in which the slurry 23 is molded into a solid. In the embodiment shown, the first and second molding screens 14, 16 together define the entire void 26. However, in some embodiments, additional screens (e.g., a third, fourth, etc) screen may be used to also define the void 26. The second molding screen 16 provides a corresponding (but opposite) shape to the first molding screen 14 such that the finished molded part has a substantially uniform cross section. Alternatively, the second molding screen 16 can have a completely different shape altogether from the first molding screen 14, depending on the application of the material output. Similar to the first molding screen 14, this second molding screen 16 can be changed out and customized, to exude different materials characteristics, to include (but not limited to): shape, texture, and pattern. The openings 32 are also preferably sized to retain the fibers in the slurry 23 within the void as the slurry 23 is molded into a solid during the molding process. For example, openings 32 have a diameter preferably range from approximately 0.1 mm to approximately 50 mm, and openings 28 between approximately 0.5 mm and approximately 10 mm have been found to have particular utility. Even more preferably, the openings are between approximately 0.5 mm and approximately 2 mm. The size of the openings 32 may be selected based on a number of factors, including the size of the fibers in the slurry 23, the amount of water necessary for draining, and the surface texture of the final molded product. The openings 32 can be the same or different to the size and shape of the openings 28 in the first molding screen 14. The secondary molding screen 16 may also include secondary relief patterns 33 similar to those described in conjunction with the first molding screen 14.

The first and second molding screens 14, 16 can be made from high-grade stainless steel, other resistant metals including Inconel types, resistant plastics such as polyoxymethylenes (e.g., Delrinx®), and fluorocarbon-based polymers (e.g., Teflon™) and durable ceramics such as silicon carbide, alumina, or other materials similarly known to have suitable properties. The material may also be coated to ensure better stability and/or release of the part. The first and second molding screens 14, 16 can be 3D-printed or, for example, machined. The openings in the first and second molding screens 14, 16 allow for fluid flow from the slurry 23 and drainage out of the apparatus 10 by way of negative or positive pressure applied during the molding process. In some embodiments, it may be necessary to include support ribs or other features (not shown) to ensure structural stability of the first and second molding screens 14, 16 during repeated use under high temperatures and pressures.

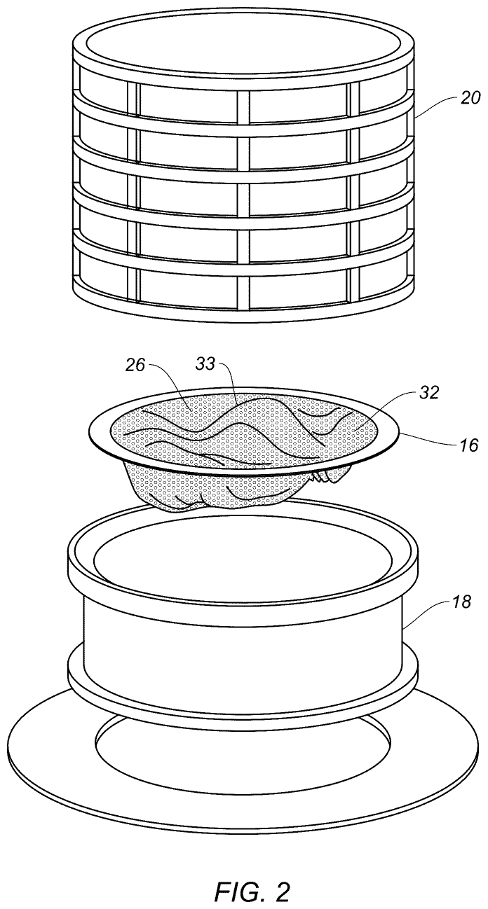

Referring now to FIGS. 1 and 2, the second pressing unit 18 includes a second inlet 38 that can be used as a port to apply either a vacuum or pressure, or to provide airflow or heat to the interior of the apparatus 10 before, during or after the molding process. The second inlet 38 may be adapted to receive a removable adapter that may be attachable to a hose or the like that is, e.g., fluid communication with a heat, airflow, vacuum and/or pressure source (not shown). The first pressing unit also provides the structural stability to one side of the apparatus 10 enabling significant pressure (e.g, from a hydraulic device) to be applied to the slurry 23 during the molding process. For example, hydraulic pressure of up to 1000 psi may be necessary depending on the desired end product. Additional ports may be included in the first pressing unit to provide for, e.g., drainage of the water from the slurry 23 during the molding process. Additionally, the second pressing unit 18 may also include one or more slots 40 for receiving a heating apparatus 22.

The negative and positive pressures applied during the molding process via, e.g., the first inlet 24 and the second inlet 38, can vary based on the needs of the particular needs of the molded product. However, in most applications, negative pressure down to 14.7 psi or positive pressures up to 500 psi may be applied via connected inlet 24, 38 and has been shown to have particular utility.

Referring now to FIGS. 1 and 2, the pressing chamber sleeve 20 at least partially surrounds the first and second pressing units 12, 18 during operation. The pressing chamber sleeve 20 at least partially encloses aspects of the system, ensures proper mold and pressing alignment and ensures the apparatus 10 stays in alignment under significant pressure and repeated use. The pressing chamber sleeve can be made from high-grade stainless steel, other resistant metals including Inconel types, resistant plastics such as polyoxymethylenes (e.g., Delrin®), fluorocarbon-based polymers (Teflon™), or other materials known to have similar suitable properties. The material may also be coated to ensure better stability and/or release of the part.

Referring now to FIG. 1, at least one heating apparatus 22 (e.g., a heating cartridge) can be utilized during typical operation of the apparatus 10. In some embodiments, the heating required can be defined as wattage required to hit temperature setpoints within a given time. Typical wattage ranges from 1500 W-2500 W; however, the range may vary depending on the size of molds used, dwell time, cycle time, water content and ambient temperature. The pressure and heat can be utilized to effectively remove the desired amount of the remaining fluid (e.g., water) from the slurry 23 and bond the fibers to one another such that a final solid fibrous molded part 25 is formed. In some embodiments, it may be desirable to remove substantially all of the water from the slurry 23. In other embodiments, it may be desirable to tune the system in order to maintain some or most of the water in the slurry 23.

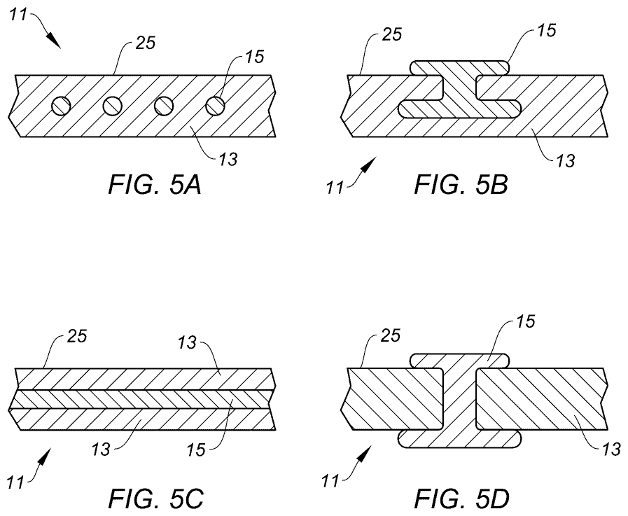

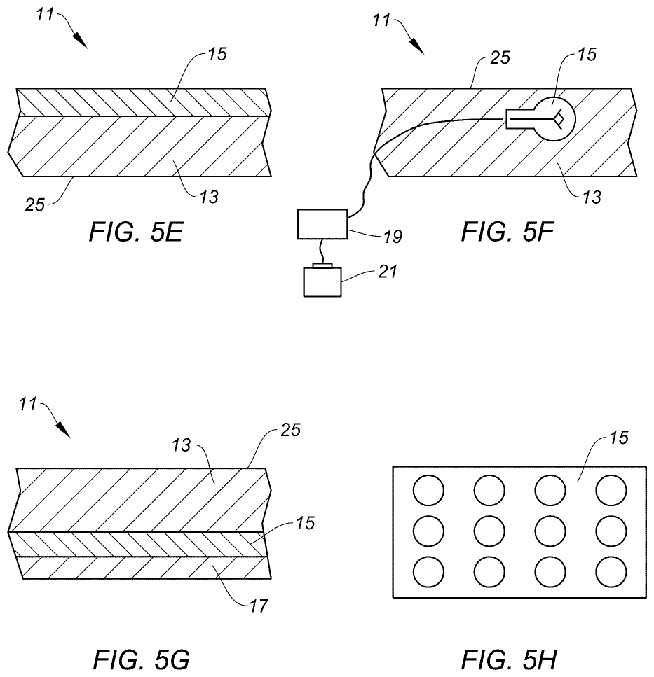

Referring now to FIGS. 5A-H, the second element 15 can be comprised of a single item (see e.g. FIG. 5B) or multiple items (see e.g., FIG. 5B) and is intended to add physical characteristics, visual characteristics, structural characteristics, and/or functional capabilities not present in the first material. Examples of a second element 15 that are known to provide visual characteristics different from the first material 13 include colored elements in the form of, e.g., thermoplastics, fabrics, rubber, wires, 3D printer inks, fibers, contrast fibers, glitter, pieces of recycled items, yarn, filaments, tubes, seeds, plant materials, wool/fur/hair; textured materials (e.g., woven, knitted or non-woven substrate fabric); Light-responsive fibers and/or elements; temperature-responsive fibers and/or elements; pressure-or touch-responsive elements; beads; keepsakes; mirrors; and various materials including, but limited to leather, fabric, film, coating, rubber, and vinyl.

Examples of a second element 15 that are known to provide functions that are different from the first material 13 include both powered items and non-powered items. Examples of powered items that can be utilized as a second element 15 include lights; haptic elements; sensors; RIFD tags; microchips; communication or memory device; electronics including connections, ports, and circuitry; conductive fibers; optical fibers; electronic devices (such as, but not limited to, speakers, radios, computers, phones, televisions); control panels; batteries, capacitors, or other power sources; solar panels or solar energy collector; and screens. Examples of non-powered items that can be utilized as a second element 15 include magnets; keys; eyelets; and cleaning liquid.

Examples of a second element 15 that are known to provide structural characteristics that are different from the first material 13 include padding, cushioning, wadding or batting; interior lining, pockets, interfacing; support and/or structural elements like heel counters and toe puffs on shoe uppers; closures like zippers, buttons, hooks, laces, ties, snaps, magnets, and Velcro; and air cushion(s).

Continuing to refer to FIGS. 5A-E, the first material 13 and the second element 15 can be configured relative to one another in a number of manners, or a combination thereof. For example, the second element 15 can be completely embedded within (i.e., fully encased within) the first material 13 (see e.g., FIG. 5A). In another embodiment, the second element 15 can be partially embedded within the first material 13 in a manner such that at least a portion of the second element 15 is generally surrounded by the first material 13 in a manner that retains the second element 15 (see e.g., FIG. 5B). In a further embodiment, in certain instances where the second element 15 is bonded to at least a portion of a surface of the first material 13 during the process of forming the first material 13 and/or sandwiched between two pieces of the first material 13 (see e.g., FIGS. 5C and 5E). In these embodiments, additional ingredients (e.g., adhesives) may be added to the mold or included in the slurry 23 that enhance bonding. In even further embodiments the second element 15 may extend through 13 the first material 13 (see e.g., FIG. 5D).

Referring to FIG. 5F, the second element 15 is a powered device (e.g., a light) that is fully embedded within the first material 13. In the embodiment shown, the second element is in electronic communication with a microcontroller 19 and a power source 21. Although the microcontroller 19 and a power source 21 are connected via a wire and are located external to the first material 13, the present invention is not so limited and the microcontroller 19 and/or the power source 21 could be partially or fully embedded within the first material 13.

Referring now to FIG. 5G, additional elements (e.g., a third element 17) can be added to the article of the present invention either during the molding operation in a similar fashion to the second element, or may be added in a subsequent operation. For example, the material layer added in FIG. 5G can be adhered to the second element 15 or, optionally, the first material 13 (not shown).

The second element may be of any suitable shape acceptable to the designer. Some shapes may have particular utility. For example, the second element in FIG. 5G has a webbed shaped with a variety of holes therein with the intention that, when embedded within the first material 13, the second element will have an enhanced interaction with the first material 13 due to the first material 13 connecting through the holes, etc. While holes are shown in FIG. 5G, one of skill in the art would understand that there are a plethora of different shapes and sizes of the second element 15 that would provide enhanced utility in the present invention.

Generally speaking, the second element 15 may be added to the first material

during the forming operation of the first material 13. For example, in the molding operation of the present embodiment, the second element may be positioned within a mold void 26 prior to adding the slurry 23. However, the present invention is not so limited and the second element 15 may be added after the slurry 23 is added but prior to the first material 13 (i.e., the solid fibrous molded part 25) being formed. The timing of the introduction of the second element 15 to either the mold void 26 or to the slurry 23 in the mold void 26 depends on a number of factors including but not limited to the characteristics of the second element 15 and type of forming operation utilized.

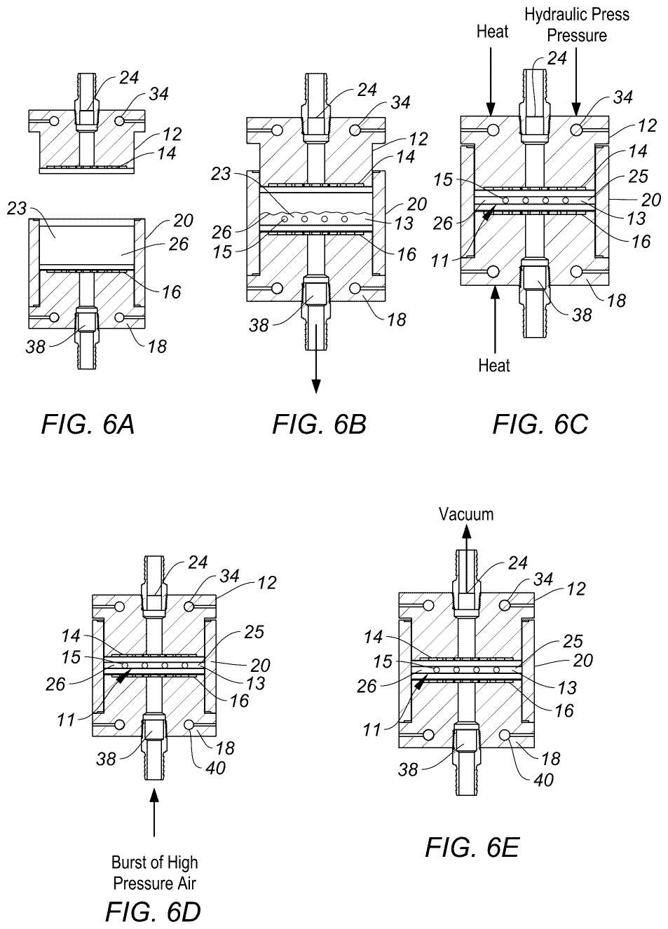

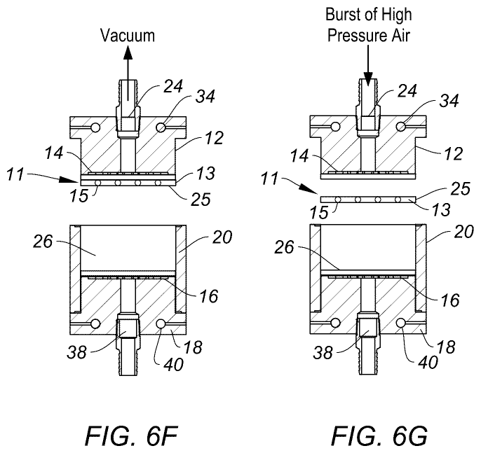

Referring to FIGS. 6A-G, during typical operation, a first molding screen 14 is positioned on the first pressing unit 12 and a second molding screen 16 is positioned on the second pressing unit 18. The first and second pressing units 12, 18 are positioned such that they are slidably engaged within the pressing chamber sleeve.

The slurry 23 is provided into the void 26 partially formed by the second molding screen 16. The second element 15 is added to the slurry 23 inside the void 26 such that the second element is at least partially within the slurry 23.

The first pressing unit 12, along with the first molding screen 14, is then slid partially towards the second molding screen 16 and the second pressing unit 18, as shown in FIG. 5B.

A vacuum may optionally be applied to the second inlet 38 such that water from the slurry 23 is drained and the slurry 23 commences dewatering. Referring now to FIG. 6C, heat is applied to the first and/or second pressing units 14, 18 via one or more heating apparatus 22 and pressure is also applied to the first and/or second pressing units 12, 18 via, e.g., a hydraulic press such that the first pressing unit 12 continues to slide relative to the pressing chamber sleeve 20 towards the second pressing unit 18 until it reaches the pre-determined final position or applied pressure. The heat and pressure are applied for a pre-determined amount of time to drain and/or evaporate the water from the slurry 23 and to bond the fibers to one another resulting in a solid fibrous molded part 25. The secondary relief patterns 30 and openings 28, 32 in the first and second molding screens 14, 16 impart a texture on the surface of the solid fibrous molded part 25. The second element 15 may either remain substantially unchanged or may alter in, e.g., shape due to the mold design, or molding temperature and forces.

Referring now to FIGS. 6D and 6E, short bursts of pressurized fluid (e.g., air, water, etc.) are applied through the second inlet 38 and a negative pressure may be applied through the first inlet 24. Referring now to FIG. 6F, the first pressing unit 12, along with the first molding screen 14 and the final solid fibrous molded part 25 with the second element 15 at least partially embedded therein are slid relative to the pressing chamber sleeve 20 away from the second molding screen 16. Referring now to FIG. 6G, a burst of pressurized fluid (e.g., air, water, etc.) is applied through the first inlet 24 to release the solid fibrous molded part 25 with the second element 15 at least partially embedded therein.

In some embodiments, the solid fibrous molded part 25 may need additional time outside the mold to dry. Additionally, some post mold forming steps may be carried out to achieve the desired shape. Optionally, additional secondary operations such as, but not limited to, rinsing and/or the application of coatings can be carried out on the final solid fibrous molded part 25 before and/or after removal from the apparatus.

Although a molding operation is described herein for forming the slurry 23 into the solid fibrous molded part 25, other operations may be utilized. Other operations include, but are not limited to, 3D printing, casting the solid fibrous molded part by pouring the slurry 23 into a form and casting the solid fibrous molded part by pouring the slurry 23 into a form and then pressing into shape.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A shaped soft goods article, comprising:
a first material, the first material comprising a unitary non-woven material having at least one three-dimensional feature; and
at least one second element at least partially embedded within the first material;
wherein the first material is comprised of at least one type of natural or synthetic fibers and at least one of crosslinkers, natural and/or synthetic adhesives, biobased and/or synthetic thermoplastics, including nanocellulose, and/or latex.

2. The shaped soft goods article of claim 1 wherein there is more than one second element.

3. The shaped soft goods article of claim 1 wherein the second element is an electronic device or component thereof.

4. The shaped soft goods article of claim 3 where in the second element is selected from a group comprised of a light, a haptic element, a sensor, a RIFD tag, a microchip, a communication or memory device, a speaker, a radio, a computer, a phone, a television, a screen, and a control panel.

5. The shaped soft goods article of claim 3 where in the second element is selected from a group comprised of a battery, a capacitor, and a solar panel or solar energy collector.

6. The shaped soft goods article of claim 3 where in the second element is selected from a group comprised of electrical circuitry, conductive fibers, and optical fibers.

7. The shaped soft goods article of claim 1 where in the second element is a decorative element.

8. The shaped soft goods article of claim 7 where in the second element is at least partially comprised of at least one material selected from a group comprising: thermoplastics, fabrics, rubber, wires, 3D printer inks, fibers, contrast fibers, glitter, yarn, filaments, tubes, seeds, plant materials, wool, fur, hair, leather, fabric, film, coating, rubber, and vinyl.

9. The shaped soft goods article of claim 7 where in the second element is selected from a group comprised of a light-responsive fiber, a temperature-responsive fiber, pressure-responsive elements, touch-responsive elements, beads, and a mirror.

10. The shaped soft goods article of claim 1 wherein the second element is partially embedded within the first material.

11. The shaped soft goods article of claim 1 wherein the second element is fully embedded within the first material.

12. The shaped soft goods article of claim 1 wherein the first material defines an outer surface and the second element is bonded to the outer surface of the first material.

13. The shaped soft goods article of claim 1 wherein a third element is affixed to one of the first material and the second element.

14. The shaped soft goods article of claim 1 wherein the second element extends through the first material.

15. A method for making a shaped soft goods article, including the steps of:
mixing at least one type of natural or synthetic fibers and at least one of crosslinkers, natural and/or synthetic adhesives, biobased and/or synthetic thermoplastics, including nanocellulose, and/or latex into an aqueous slurry;
providing an amount of the slurry into a mold form;
draining at least some of the water from the aqueous slurry to leave behind a mixture that includes at least the fibers;
at least partially embedding at least a second element into either the aqueous slurry or the mixture;
drying the mixture to remove additional water resulting in a solid fibrous molded article; and
removing the solid fibrous molded article having the second element at least partially embedded therein from the mold form.

16. The method of making a shaped soft goods article of claim 15 wherein more than one second element is at least partially embedded into either the aqueous slurry or the mixture.

17. The method of making a shaped soft goods article of claim 15 wherein the second element is an electronic device or component thereof.

18. The method of making a shaped soft goods article of claim 15 wherein the second element is decorative element.

19. The method of making a shaped soft goods article of claim 15 wherein the second element is partially embedded within the solid fibrous molded article when the article is removed from the mold form.

20. The method of making a shaped soft goods article of claim 15 wherein the second element is fully embedded within the solid fibrous molded article when the article is removed from the mold form.

21. The method of making a shaped soft goods article of claim 15 wherein the first material defines an outer surface and the second element is bonded to the outer surface of the first material when the article is removed from the mold form.

22. The shaped soft goods article of claim 1 wherein the second element extends through the first material when the article is removed from the mold form.

23. A method for forming a shaped soft goods article, including the steps of:
mixing at least one type of natural or synthetic fibers and at least one of crosslinkers, natural and/or synthetic adhesives, biobased and/or synthetic thermoplastics, including nanocellulose, and/or latex into an aqueous slurry;
draining at least some of the water from the aqueous slurry to leave behind a mixture;
embedding a second element at least partially within the mixture;
drying the mixture to remove additional water,
pressing the mixture into a desired shape in a press that includes at least one three-dimensional shape; and
removing a solid fibrous article having a second element at least partially embedded therein from the press.
